(19) United States
(12) Patent Application Publication
(10) Pub. No.: US 2020/0156404 A1
(43) Pub. Date: May 21, 2020

(54) A NEW GENERATION PASSENGER VEHICLE STEEL WHEEL

(71) Applicant: WHEELS INDIA LIMITED, CHENNAI (IN)

(72) Inventor: Sundararajan Thiyagarajan, CHENNAI (IN)

(73) Assignee: WHEELS INDIA LIMITED, CHENNAI (IN)

(21) Appl. No.: 15/771,095

(22) PCT Filed: Feb. 20, 2016
(86) PCT No.: PCT/IB2016/050922

§ 371 Date: Apr. 26, 2018

(30) Foreign Application Priority Data
Feb. 2, 2016 (IN) 201641003738

(51) Int. Cl. B60B 3/10; B60B 3/00; B60B 3/04; B60B 3/12; B60B 3/16

(52) U.S. Cl. CPC B60B 3/10; B60B 2900/311; B60B 3/044; B60B 3/045; B60B 3/12; B60B 3/16; B60B 2360/102; B60B 2900/513; B60B 2900/1216; B60B 2900/112; B60B 2900/572; B60Y 2200/11; B60B 2310/3022; B60B 2900/113; B60B 3/005

(57) ABSTRACT

The present invention provides a new style or design for a steel wheel 200 in passenger vehicle with improvement in performance and aesthetics. In the new design of the steel wheel 200, a vent-hole outer region 214 is folded 206 inwardly to form two ends, wherein one end is welded to an outboard bead seat 212 of the steel wheel rim and the other end welded to a portion of an outboard flange portion 204. The inward folding 206 of the vent hole outer region 214 increases the vent-hole 205 area and thereby improves better air flow and cooling of a brake drum. The passenger vehicle steel wheel 200 design enables for spot welding throughout the circumference of the rim-disc contact surface for better contact and higher load/moment transfer. Further, the passenger vehicle steel wheel 200 may utilize an existing rim without any special machining or modification.

### FIELD OF INVENTION

The embodiment herein generally relates to a passenger vehicle wheel. Specifically the present invention provides a novel design for a passenger vehicle steel wheel with similar aesthetics as in alloy wheel.

### BACKGROUND AND PRIOR ART

In general, vehicle wheels are classified into two types based on the material used for manufacturing the wheel. The materials can be non-ferrous or ferrous material. That is in non-ferrous material, alloys such as aluminum or magnesium-based alloys are utilized for manufacturing wheels and this type of wheels are referred as alloy wheels. However in ferrous-based materials, various steel compositions are utilized for manufacturing wheels and these wheels are commonly referred to as steel wheels.

In current trend, the vehicle wheels manufacturing companies are showing interest in alloy wheels because of the aesthetic look of the wheel. Even though the alloy wheels are expensive, people demand for alloy wheels for the vehicles instead of steel wheel owing to their aesthetic appearance.

While considering steel wheel, even though their appearance is not so appealing due to their process difficulties, the steel wheels are cheaper compared to the alloy wheels. Further the steel can also be repaired easily according to the preference. But the aesthetic look of the alloy wheel is not attained in the steel wheel still now.

Therefore, there is a need to develop a steel wheel with similar aesthetic look as in the alloy wheel. At the same time the properties of steel wheel that is durability and lesser cost also has to be retained.

### OBJECTS OF THE INVENTION

Some of the objects of the present disclosure are described herein below:

A main object of the present invention to provide a new design and material for a passenger vehicle wheel that facilitates an improved performance and aesthetics.

Another object of the present invention to provide a highly durable wheel for the passenger vehicle.

Still another object of the present invention to provide a passenger vehicle wheel with a vent-hole folding at the disc that is welded on to a bead seat of a rim.

Yet another object of the present invention to provide a passenger vehicle wheel which has a wheel disc without a flange portion.

Another object of the present invention is to utilize a standard profile rim with flanges at both sides to provide a passenger vehicle wheel of new style.

Another object of the present invention is to utilize a standard profile rim that does not require any special machining or modification to provide a passenger vehicle wheel.

Another object of the present invention to provide a passenger vehicle wheel with wide range of rim sizes.

Another object of the present invention to provide a passenger vehicle wheel with the ability to weld (Resistance or Arc) throughout the circumference of the rim-disc contact surface for better contact and higher load/moment transfer.

Another object of the present invention to provide a passenger vehicle wheel with bigger disc surface that provides room for more styling and aesthetic improvements.

Another object of the present invention to provide a passenger vehicle wheel that can enclose the entire area of the wheel and hence eliminates the need for a wheel cap.

Another object of the present invention to provide a passenger vehicle wheel that may almost similar to that of alloy wheels.

Another object of the present invention to provide a passenger vehicle wheel for lesser price than the alloy wheel.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

In view of the foregoing, an embodiment herein provides a passenger vehicle steel wheel in such a way to improve the performance and aesthetics as that of an alloy wheel. The steel wheel may include an inboard flange portion, an outboard flange portion, an inboard bead seat, an outboard bead seat, a rim base, an inboard safety hump, an outboard safety hump, a vent-hole, a hub mounting plate, plurality of lug bolt hole, a valve hole, a central bore and a wheel disc with plurality of spokes.

In this embodiment, the position and shape of the vent-hole and disc may be modified to improve the performance of the steel wheel. Further, the wheel disc is designed without the flange portion. The vent-hole has a folding that may get welded to the bead seat of the rim instead of the flange portion of the disc being welded to the bead seat. This may significantly increases the vent-hole area which can improve better air flow and cooling of brake drum. The new steel wheel design can enable the ability to weld segmental or throughout the circumference of the rim-disc contact surface, for better contact and higher load/moment transfer. Further the bigger wheel disc surface available provides room for more styling and aesthetic improvements.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a wheel profile of regular steel vehicle wheel, according to prior art;

FIG. 1b illustrates a wheel profile of first generation style wheel, according to prior art;

FIG. 1c illustrates the wheel profile of novel aesthetic steel wheel, according to an embodiment therein;

FIG. 2 illustrates the new design for passenger vehicle wheel, according to an embodiment therein; and

FIG. 3 illustrates the sectional view of rim and disc contact for the new passenger vehicle wheel, according to an embodiment therein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

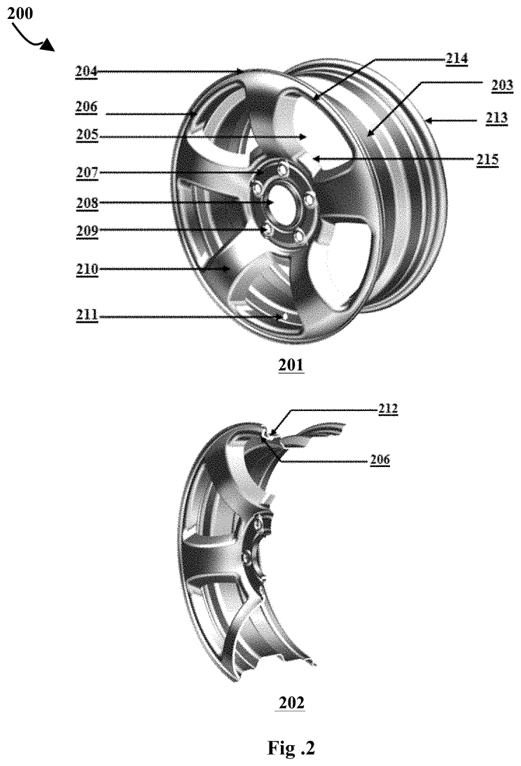

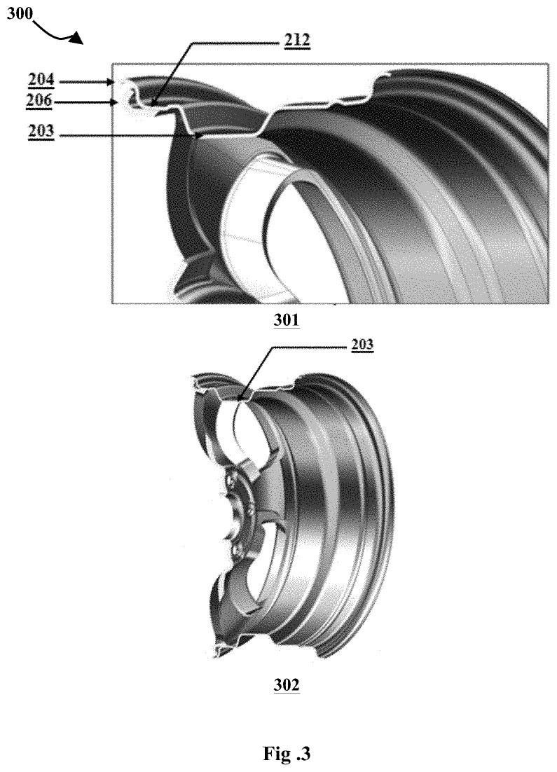

As mentioned above, there is a need to provide a new design and material for a passenger vehicle wheel that facilitates an improved performance and aesthetics. The embodiments herein achieve this by providing a novel aesthetic ferrous-based wheel with a vent-hole folding in a disc that is welded to the bead seat of a rim instead of the disc being welded to the bead seat. Referring now to the drawings, and more particularly to FIGS. 2 through 3, where similar reference characters denote corresponding features consistently throughout the figures, there are shown preferred embodiments. The ferrous-based wheel can be made of a material that includes steel, stainless steel and other ferrous-based material.

According to an embodiment, the present inventor(s) has attempted to develop a steel wheel in such a way to improve the performance and aesthetics as that of an alloy wheel. The steel wheel may include an inboard flange portion, an outboard flange portion, an inboard bead seat, an outboard bead seat, a rim base, an inboard safety hump, an outboard safety hump, a vent-hole, a hub mounting plate, plurality of lug bolt hole, a valve hole, a central bore and a wheel disc with plurality of spokes. In the embodiment, the position and shape of the vent-hole and disc may be modified to improve the performance of the steel wheel. Further, the wheel disc is designed without the flange portion. The vent-hole has a folding that may get welded to the bead seat of the rim instead of the flange portion of the disc being welded to the bead seat. This may significantly increases the vent-hole area which can improve better air flow and cooling of brake drum. The new steel wheel design can enable the ability to weld segmental or throughout the circumference of the rim-disc contact surface, for better contact and higher load/moment transfer. Further the bigger wheel disc surface available provides room for more styling and aesthetic improvements.

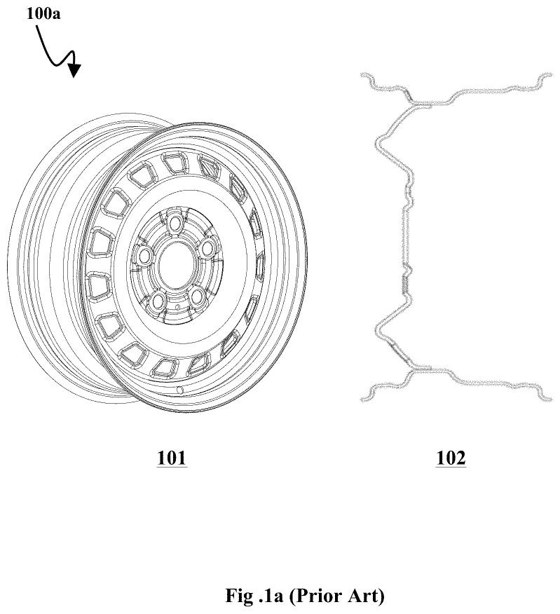

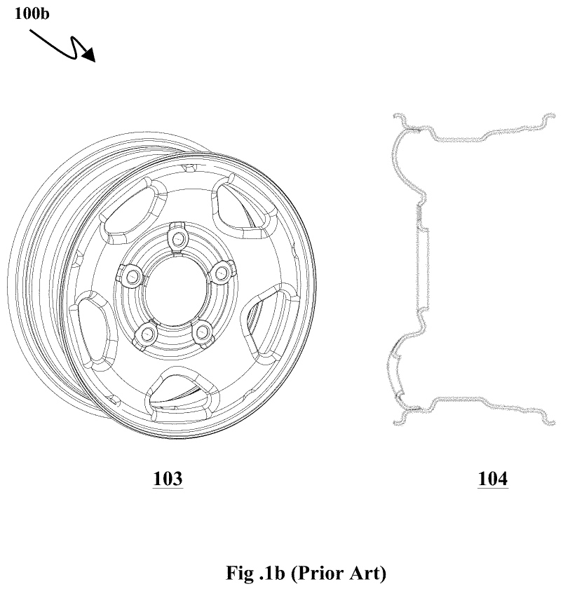

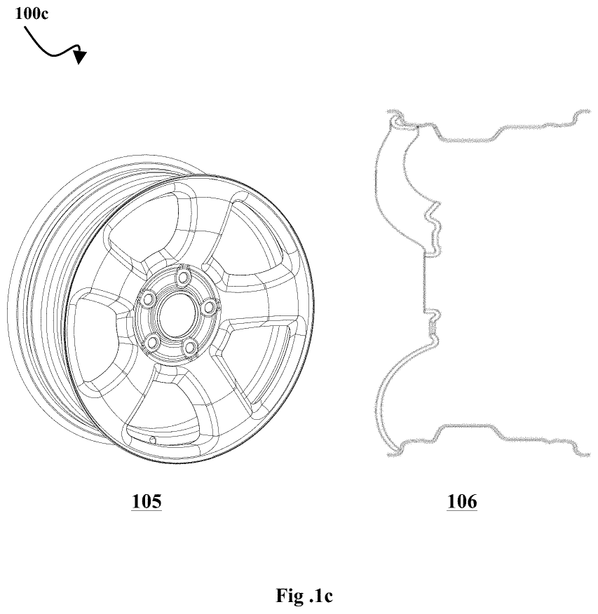

FIG. 1a illustrates a wheel profile 100a of regular steel wheel, according to prior art. FIG. 1b illustrates a wheel profile 100b of first generation style wheel, according to prior art. In the regular vehicle wheel 101, the wheel profile 102 clearly shows the position of the wheel disc. The wheel disc is attached to the rim base for the regular wheel. In the first generation style wheel 103, the wheel disc is connected to the bead seat band. From the wheel profile of the style steel wheel 104, the connection between the wheel disc and the outboard bead seat is visible.

FIG. 1c illustrates wheel profile 100c of passenger vehicle steel wheel 100c, according to an embodiment. According to present invention, the wheel disc of the vehicle steel wheel 105 is embossed outwardly with plurality of vent holes. The vent hole is folded inwardly to provide the wheel disc, an embossed aesthetic look as in alloy wheel. In between the vent holes the passenger vehicle steel wheel may have plurality of spokes that connects the bead seat of the rim and the hub mounting plate. The mounting plate is provided with plurality of lug bolt holes to mount the wheel with an axle. Further the rim is provided with a valve hole to fill air in tyre. In an embodiment, the vent-hole folding of the wheel disc is welded on to a bead seat of the rim. The wheel profile of the vehicle steel wheel 106 shows the inward vent-hole folding being welded to the bead seat of the rim. Further the plurality of spokes from the hub mounting plate may get attached to the outboard flange portion of the rim.

FIG. 2 illustrates the new design for passenger vehicle wheel 200, according to an embodiment. The front perspective view 201 of the new design for a passenger vehicle steel wheel include an outboard flange portion 204, plurality of vent-hole 205, plurality of vent-hole folding portion 206, at least one hub mounting plate 207, at least one central bore 208, plurality of lug bolt hole 209, at least one wheel disc with plurality of spokes 210, and at least one valve hole 211. According to present invention, the vent-hole folding may get welded to the bead seat of the rim instead of disc being welded to the bead seat. Further the vent-hole folding can be utilized as the flange for rim-disc welding. This may significantly increases the vent-hole area, which may improve better air flow and cooling of the brake drum. The perspective cross-section view of the passenger vehicle steel wheel 202 may provide the visibility of the vent folding 206 and the flange portion 204. Further the perspective cross-section view may show separation of the wheel disc 210 and bead seat 212. The passenger vehicle steel wheel 202 can enable the ability to weld segmental or throughout the circumference of the rim-disc contact surface, for better contact and higher load/moment transfer. Further the bigger wheel disc surface available provides room for more styling and aesthetic improvements.

FIG. 3 illustrates the sectional view of rim and disc contact 300 for the passenger vehicle steel wheel, according to an embodiment. A top portion of the sectional view 301 of the rim and disc contact can show the vent-hole folding 206 and the wheel disc portion. Further the sectional view of rim and disc contact can show the position of rim base 203 and bead seat position. The vent-hole folding 206 may get welded to the rim for rim-disc welding. Therefore, the passenger vehicle steel wheel of present invention can improve the performance and aesthetics of the vehicle wheel.

According to an embodiment, the passenger vehicle steel wheel may enclose the entire area of the wheel and hence it eliminates the requirement of a wheel cap. The passenger vehicle steel wheel's aesthetic is almost similar to that of the alloy wheels and the cost is much lower than the alloy wheel and the durability also can be increased. Further the passenger vehicle steel wheel can be manufactured over a wide range of sizes. The rim width can range from 4″ to 10″ while the rim diameter can be increased from 10″ to a high 24″. In an embodiment, for making the passenger vehicle steel wheel, existing rims, which has flange portion on both sides can be used and the existing rim may not be subjected to any special machining or modification.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A new generation passenger vehicle steel wheel comprising,
a cylindrical wheel rim including a rim base, an inboard flange portion, an outboard flange portion, an inboard bead seat, an outboard bead seat, an inboard safety hump and an outboard safety hump;
plurality of vent-holes, wherein the vent holes are folded inwardly and that is welded to the outboard bead seat portion of the wheel rim instead of the flange portion of the disc being welded to the outboard bead seat;
a hub mounting plate with plurality of lug bolt hole;
a valve hole;
a central bore; and
a wheel disc with plurality of spokes, wherein the plurality of spokes are embossed outwardly and the plurality of spokes connects the outboard flange portion and the hub mounting plate.

2. The passenger vehicle steel wheel of claim 1, wherein the position and shape of the vent-hole and the vent hole folding on the wheel disc improves the performance of the steel wheel.

3. The passenger vehicle steel wheel of claim 1, wherein the passenger vehicle steel wheel design is also implemented on existing standard profile rim and the wheel rim need not subject to any special machining or modification.

4. The passenger vehicle steel wheel of claim 1, wherein the wheel disc is designed without a flange portion.

5. The passenger vehicle steel wheel of claim 1, wherein the inward vent hole folding increases the vent-hole area and that improves better air flow and cooling of a brake drum.

6. The passenger vehicle steel wheel of claim 1, wherein the inward vent hole folding enables the ability to spot welding throughout the circumference of the rim-disc contact surface, for better contact and higher load or moment transfer.

7. The passenger vehicle steel wheel of claim 1, wherein the bigger wheel disc surface available provides room for more styling and aesthetic improvements.

8. The passenger vehicle steel wheel of claim 1, wherein the passenger vehicle steel wheel encloses the entire area of the wheel and hence it eliminates the requirement of a wheel cap.

9. The passenger vehicle steel wheel of claim 1, wherein the passenger vehicle steel wheel is manufactured over a wide range of sizes with a rim width range from 4″ to 10″ and the rim diameter ranging from 10″ to 24″.
